(19) United States
(12) Patent Application Publication
(10) Pub. No.: US 2019/0275850 A1
(43) Pub. Date: Sep. 12, 2019

(54) TOWING KIT HAVING A MULTI-HITCH

(71) Applicant: Erick Pucheu, Magnolia, TX (US)

(72) Inventor: Erick Pucheu, Magnolia, TX (US)

(21) Appl. No.: 15/917,087

(22) Filed: Mar. 9, 2018

(51) Int. Cl. B60D 1/07; B60D 1/06; B60D 1/42

(52) U.S. Cl. CPC B60D 1/07; B60D 1/42; B60D 1/06

(57) ABSTRACT

Towing kits and towing components are described. A towing kit can include a hitch mount to connect a pintle adapter and a multi-hitch to a tow vehicle. The pintle adapter can include an adapter channel to receive the hitch mount and a latch mechanism to retain a pintle loop when the towing kit is in a pintle towing mode. The multi-hitch can include a ball mount section having one or more hitch balls. The hitch balls can retain the pintle loop in the pintle towing mode, or receive a ball hitch when the towing kit is in a ball hitch towing mode. The multi-hitch can also include a clevis mount section having shear plates to hold a clevis pin when the towing kit is in a clevis towing mode. Other embodiments are also described and claimed.

### BACKGROUND

### Field

Embodiments related to towing hitches, are disclosed. More particularly, embodiments related to towing hitches having several hitch balls, are disclosed.

### Background Information

A towing kit can be used to pull a load, such as a trailer, by a vehicle, such as a truck or tractor. Towing kits can include a drawbar to attach to a receiver tube on the vehicle. The drawbar can also include (or be attached to) a towing component, such as a towball. The towing component can connect to a hitch on the load, such as a ball hitch. A size of the hitch can vary from load to load. For example, heavier trailers may have larger ball hitches, that must be pulled by a larger towball. Accordingly, a driver may store several towing components in the vehicle to adapt the drawbar to differently-sized loads.

### SUMMARY

Towing kits and towing components are described. In an embodiment, a towing kit includes a hitch mount having an elongated mounting tube. The towing kit includes a pintle adapter that includes a latch mechanism and is mountable on the mounting tube. The towing kit includes a multi-hitch that includes a ball mount section and a clevis mount section, and is mountable on the mounting tube. The ball mount section can have several hitch balls, and the clevis mount section can have several shear plates. The pintle adapter, multi-hitch, and mounting tube can be interconnected by one or more tow pins to pull a load in one of several modes. In a pintle hitch towing mode, the ball mount section can be extended forward and the latch mechanism can be advanced to hold a pintle loop between the pintle adapter, the mounting tube, and a ball hitch. In a ball hitch towing mode, the ball mount section can be extended forward and the latch mechanism can be retracted to hold a ball coupler on a hitch ball. In a clevis hitch towing mode, the clevis mount section can be extended forward to hold a tongue between the shear plates. The towing kit is therefore adaptable to tow loads in any of several modes using the same components, which may remain mounted together on a tow vehicle.

In an embodiment, a tow pin includes a pin portion and a head portion. The pin portion includes a shaft extending from a shaft base. The head portion includes a head sidewall and a head base. The shaft of the pin portion extends through a hole in the head base, and the head sidewall extends from the head base around the shaft base. Accordingly, the pin portion and the head portion are coupled to one another such that the head portion can rotate freely relative to the pin portion when the pin portion is holding several components of a towing kit together. The relative movement between the head portion and the pin portion can avoid tangling of a tether that connects the head portion to the towing kit.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. Also, in the interest of conciseness and reducing the total number of figures, a given figure may be used to illustrate the features of more than one embodiment of the invention, and not all elements in the figure may be required for a given embodiment.

FIG. 1 is a perspective view of a towing kit in a pintle hitch towing mode, in accordance with an embodiment.

FIG. 2 is a side view of a towing kit, in accordance with an embodiment.

FIG. 3 is a top view of a towing kit, in accordance with an embodiment.

FIG. 4 is a perspective view of a hitch mount, in accordance with an embodiment.

FIG. 5 is a front perspective view of a pintle adapter, in accordance with an embodiment.

FIG. 6 is a rear perspective view of a pintle adapter, in accordance with an embodiment.

FIG. 7 is a perspective view of a multi-hitch, in accordance with an embodiment.

FIG. 8 is a top view of a multi-hitch, in accordance with an embodiment.

FIG. 9 is a side view of a multi-hitch, in accordance with an embodiment.

FIG. 10 is a perspective view of a tow pin, in accordance with an embodiment.

FIG. 11 is a sectional view, taken about line A-A of FIG. 10, of a tow pin, in accordance with an embodiment.

FIG. 12 is a side view of a towing kit in a ball hitch towing mode, in accordance with an embodiment.

FIG. 13 is a side view of a towing kit in a clevis hitch towing mode, in accordance with an embodiment.

### DETAILED DESCRIPTION

Embodiments describe a towing kit having a multi-hitch and a pintle adapter that can be simultaneously mounted on a hitch mount in several configurations to allow the towing kit to pull a load in a pintle hitch towing mode, a ball hitch towing mode, or a clevis hitch towing mode. The towing kit can be used to connect an automotive vehicle to a trailer. The towing kit may, however, be used to connect other vehicles to other loads, such as for connecting a boat to a barge, or any other vehicle-to-load combination.

In various embodiments, description is made with reference to the figures. However, certain embodiments may be practiced without one or more of these specific details, or in combination with other known methods and configurations. In the following description, numerous specific details are set forth, such as specific configurations, dimensions, and processes, in order to provide a thorough understanding of the embodiments. In other instances, well-known processes and manufacturing techniques have not been described in particular detail in order to not unnecessarily obscure the description. Reference throughout this specification to “one embodiment,” “an embodiment,” or the like, means that a particular feature, structure, configuration, or characteristic described is included in at least one embodiment. Thus, the appearance of the phrase “one embodiment,” “an embodiment,” or the like, in various places throughout this specification are not necessarily referring to the same embodiment. Furthermore, the particular features, structures, configurations, or characteristics may be combined in any suitable manner in one or more embodiments.

The use of relative terms throughout the description may denote a relative position or direction. For example, “distal” may indicate a first direction away from a reference point, e.g., away from a tow vehicle. Similarly, “proximal” may indicate a location in a second direction opposite to the first direction, e.g., toward the tow vehicle. Such terms are provided to establish relative frames of reference, however, and are not intended to limit the use or orientation of a towing kit to a specific configuration described in the various embodiments below.

When a user stores several towing components, such as different hitch balls, in a cab or a bed of a tow vehicle, there is a risk that one or more of the towing components may be lost through theft or misplacement. Furthermore, hitch pins used to respectively connect the different towing components to a drawbar may be lost. Accordingly, the separation between towing components, which is inherent in existing towing kits, can cause increased costs and inconvenience for the user.

In an aspect, a towing kit having a mounting tube, a multi-hitch, and a pintle adapter is provided. The multi-hitch and the pintle adapter can be mounted together on the mounting tube in different towing configurations. For example, when the pintle adapter is mounted with a latch mechanism in an extended state, and the multi-hitch is mounted with a clevis mount section in a rearward position, the towing kit can be used in a pintle hitch towing mode. When the pintle adapter is mounted with the latch mechanism in a retracted state, and the multi-hitch is mounted with the clevis mount section in a rearward position, the towing kit can be used in a ball hitch towing mode. When the pintle adapter is mounted with the latch mechanism in a retracted state, and the multi-hitch is mounted with the clevis mount section in a forward position, the towing kit can be used in a clevis hitch towing mode. Accordingly, the towing kit can be used to tow several different load types while retaining all of the towing components, including hitch pins, on the receiver tube of the vehicle.

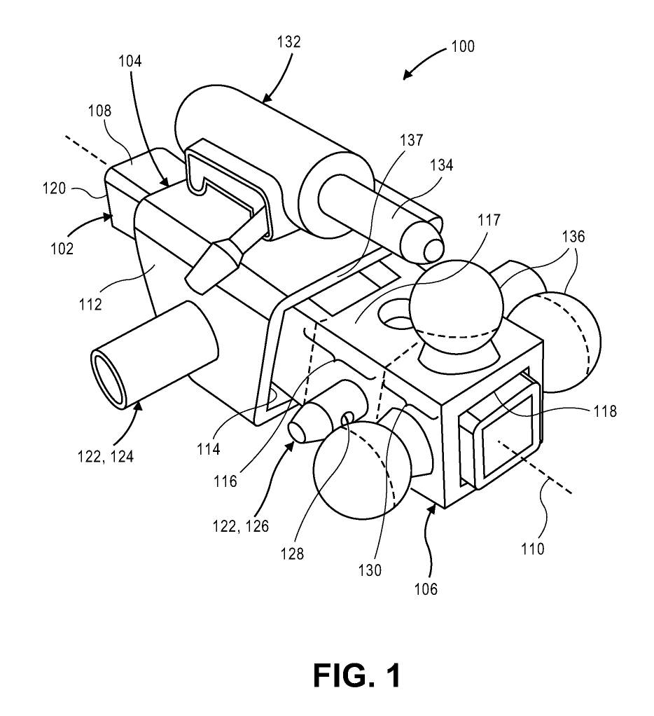

Referring to FIG. 1, a perspective view of a towing kit is shown in accordance with an embodiment. A towing kit 100 can include several components that are combined to form a towing assembly. For example, towing kit 100 can include a hitch mount 102, a pintle adapter 104, and a multi-hitch 106, each of which is described in more detail below. Pintle adapter 104 and multi-hitch 106 may be mounted on hitch mount 102 in several configurations. For example, hitch mount 102 may have a mounting tube 108 extending along a longitudinal axis 110, and mounting tube 108 can be received within respective channels of pintle adapter 104 and multi-hitch 106. More particularly, pintle adapter 104 can include an adapter wall 112 extending completely or partially around an adapter channel 114, and adapter channel 114 can receive mounting tube 108 as shown. Similarly, multi-hitch 106 can include a collar section 116 having a collar tube 117, and collar tube 117 may surround a collar channel 118 sized to receive mounting tube 108. Accordingly, both pintle adapter 104 and multi-hitch 106 can be simultaneously mounted on mounting tube 108.

As described below, hitch mount 102, pintle adapter 104, and multi-hitch 106 can include respective holes arranged along respective axes. When the holes are coaxially aligned, a tow pin 122 can be inserted through the holes to lock the respective components together. For example, an adapter pin 124 may be inserted through coaxially aligned holes in adapter wall 112 and mounting tube 108 to secure pintle adapter 104 to hitch mount 102. Similarly, a hitch pin 126 may be inserted through coaxially aligned holes in collar tube 117 and mounting tube 108 to secure multi-hitch 106 to hitch mount 102. The tow pins 122 can be held in place by a split pin (not shown) inserted through a split pin hole 128 located near the ends of the tow pins 122. Accordingly, towing kit 100 can include hitch mount 102, pintle adapter 104, and multi-hitch 106 held together in a towing assembly by tow pins 122.

The towing assembly can be connected to a vehicle. For example, a proximal end 120 of mounting tube 108 can be inserted into a receiver tube of the vehicle. Mounting tube 108 can be locked to the receiver tube by a pin. Accordingly, towing kit 100 can be fastened to the vehicle to pull a load.

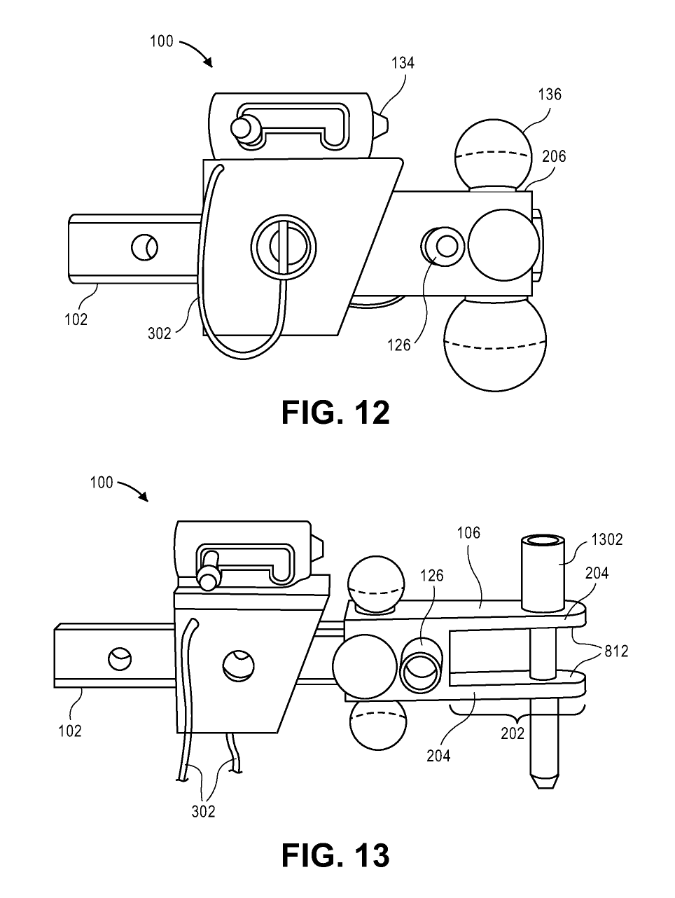

Towing kit 100 can be reconfigured depending on the load type to be pulled by the vehicle. Still referring to FIG. 1, towing kit 100 is configured with a ball mount section 130 of multi-hitch 106 in a distalmost position on mounting tube 108, and a latch mechanism 132 of pintle adapter 104 in an extended state. The pictured configuration can be referred to as a pintle hitch towing mode because a pintle loop attached to the load can be retained between an extended latch bolt 134 of latch mechanism 132, a hitch ball 136 of multi-hitch 106, an upper surface of collar tube 117, and a distal surface 137 of adapter wall 112 while pulling the load. Latch bolt 134 of latch mechanism 132 can be retracted, and multi-hitch 106 can be removed reoriented and repositioned on mounting tube 108 to reconfigure towing kit 100 in a different towing mode. For example, towing kit 100 may be configured in a ball hitch towing mode (FIG. 12) to pull a load having a ball hitch, or a clevis hitch towing mode (FIG. 13) to pull a load having a tongue hitch.

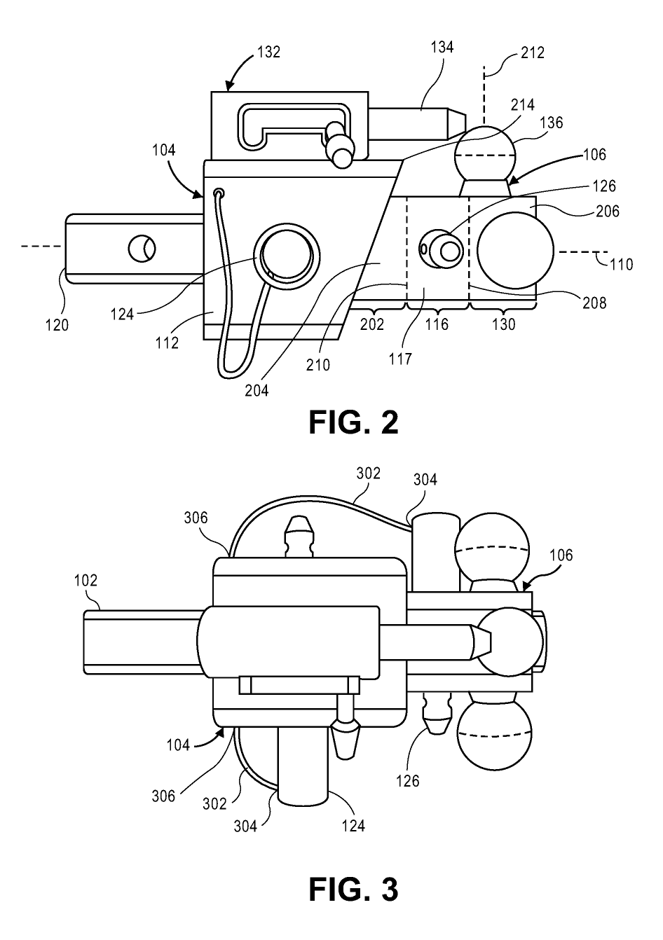

Referring to FIG. 2, a side view of a towing kit is shown in accordance with an embodiment. Multi-hitch 106 includes collar section 116 between ball mount section 130 and a clevis mount section 202. Clevis mount section 202 is partially hidden, but as described below, may include one or more shear plate 204. In an embodiment, ball mount section 130 includes a mounting wall 206 extending from a first end 208 of collar tube 117. For example, in the pintle hitch towing mode, mounting wall 206 extends in a distal direction (away from proximal end 120) from first end 208 of collar section 116. By contrast, shear plate(s) 204 of clevis mount section 202 extends from a second end 210 of collar tube 117. For example, in the pintle hitch towing mode, shear plate(s) 204 can extend in a proximal direction from second end 210 of collar section 116.

In an embodiment, latch mechanism 132 is mounted on adapter wall 112. More particularly, latch mechanism 132 can be mounted on a top surface of pintle adapter 104. Thus, when latch bolt 134 is extended, a vertical gap is disposed between latch bolt 134 and collar section 116 of multi-hitch 106.

Mounting wall 206 can receive hitch ball 136 along the hitch ball axis 212. For example, hitch ball 136 may be welded to a top surface of mounting wall 206, or hitch ball 136 may have a threaded shank that is fastened within a hole formed in the top surface of mounting wall 206. Thus, hitch ball axis 212 may be perpendicular to longitudinal axis 110 and distal to a front edge 214 of adapter wall 112. Accordingly, a horizontal gap may be disposed between front edge 214 and hitch ball 136. The vertical gap between latch pin and collar section 116, and the horizontal gap between adapter wall 112 and hitch ball 136 can provide a space to receive a pintle loop attached to a load being towed.

Referring to FIG. 3, a top view of a towing kit is shown in accordance with an embodiment. As described above, the towing components can be held together by adapter pin 124 and hitch pin 126 inserted through corresponding holes in hitch mount 102, pintle adapter 104, and multi-hitch 106. The tow pins 122 can be removed to allow the towing components to be repositioned with respect to each other. During this repositioning, it may be useful to retain tow pins 122, e.g., to avoid losing or dropping the tow pins 122. In an embodiment, towing kit 100 includes a tether 302 to attach a corresponding tow pin 122 to a corresponding towing component. For example, tether 302 may be a cord, a cable, or rope, a chain, etc., having a first tether end 304 attached to adapter pin 124 or hitch pin 126, and a second tether end 306 attached to pintle adapter 104. A single tether may be connected to both tow pins 124, 126. For example, tether 302 may pass through lateral sides of adapter wall 112 and be connected at each tether end to a respective tow pin. When a tow pin 122 is removed to unfasten the corresponding towing component, e.g., to disconnect pintle adapter 104 from hitch mount 102, the tow pin 122 can hang from pintle adapter 104 by tether 302. Accordingly, adjustment and reconfiguration of towing kit 100 can be performed while tow pin 122 is safely retained at the worksite.

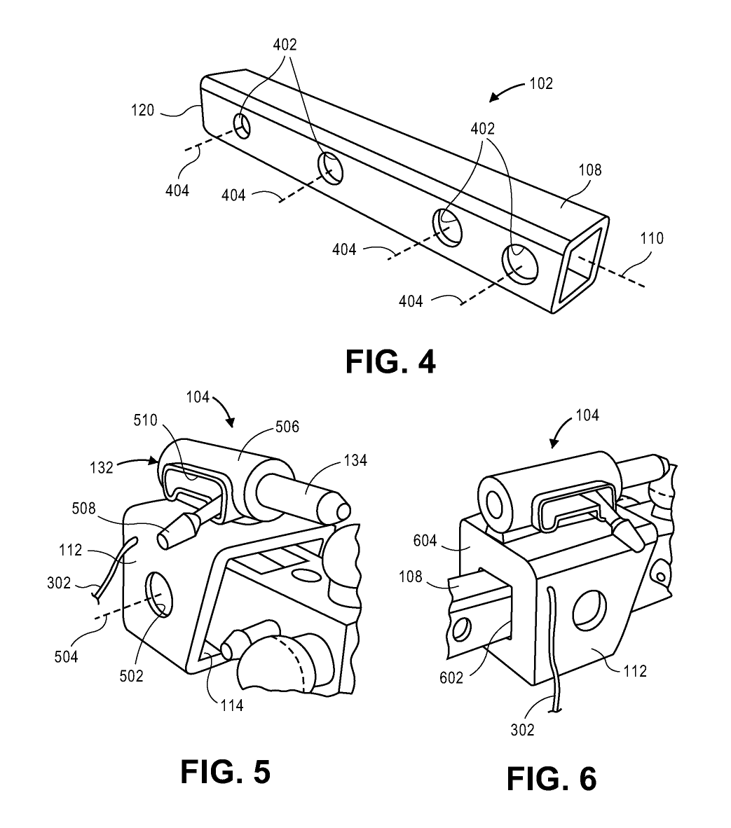

Referring to FIG. 4, a perspective view of a hitch mount is shown in accordance with an embodiment. Mounting tube 108 of hitch mount 102 can be an elongated tube having any tubular cross-sectional profile. For example, mounting tube 108 may be a square tube having a cross-sectional profile that has four sides of equal lengths, such as 2-inch lengths to fit within standard vehicle receiver tubes. The cross-sectional profile may vary, however, depending on a size or shape of the receiver tube. For example, mounting tube 108 may be a circular tube having an annular cross-sectional profile.

Hitch mount 102 may include one or more hole pairs in mounting tube 108. The term “hole pair” as used throughout the description may refer to a first hole in a first wall of the structure coaxially aligned with a second hole in a second wall of the structure. The first wall and the second wall may be parallel walls, such as in the case of a tube having a rectangular profile. The first wall and the second wall, however, may not be parallel walls, such as in the case of a tube having a circular or triangular profile. In any case, the first hole and the second hole of the hole pair can be aligned along a respective axis. Furthermore, the holes of the hole pair can be sized to receive a predetermined tow pin 122. Accordingly, a corresponding tow pin 122 can be advanced through the hole pair along the respective axis.

In an embodiment, four mounting hole pairs 402 are disposed in mounting tube 108. Each pair of mounting holes is aligned along a respective mounting hole axis 404. For example, the mounting hole axes may extend through lateral walls of mounting tube 108 perpendicular to longitudinal axis 110, and the mounting hole pairs 402 may be formed in the lateral walls. Mounting hole axes may be parallel to each other and longitudinally spaced apart from each other. Accordingly, hitch mount 102 can receive a tow pin 122 at different longitudinal locations within each of the mounting hole pairs 402.

Mounting holes in hitch mount 102 may have a same or a different size from each other. In an embodiment, a proximal-most mounting hole pair 402 can include holes having a diameter of 0.75 inch to receive a pin to latch mounting tube 108 to a receiver tube of the vehicle. By contrast, one or more mounting hole pairs 402 distal to the proximal-most mounting hole pair 402 may include holes having a larger diameter to receive adapter pin 124 or hitch pin 126. For example, the three mounting hole pairs 402 distal to the proximal-most mounting hole pair 402 may include holes having a diameter of 1.0 inch to receive adapter pin 124 or hitch pin 126. Accordingly, at least two of the three mounting hole pairs 402 distal to the proximal-most mounting hole pair 402 may be used in the different towing modes.

Referring to FIG. 5, a front perspective view of a pintle adapter is shown in accordance with an embodiment. Pintle adapter 104 can include a pair of adapter holes to align with one of the mounting hole pairs of hitch mount 102. In an embodiment, adapter hole pair 502 is formed in adapter wall 112. For example, holes may be drilled through opposite lateral sides of adapter wall 112 along an adapter hole axis 504. Adapter hole axis 504 can be perpendicular to longitudinal axis 110. Thus, adapter hole axis 504 may be aligned with mounting hole axis 404 such that adapter pin 124 can be inserted through the lateral walls of both pintle adapter 104 and hitch mount 102 to hold the towing components together. By way of example, adapter pin 124 can be inserted through adapter hole pair 502 and the mounting hole pair 402 nearest to the proximal-most mounting hole pair 402 to hold pintle adapter 104 in a medial location on mounting tube 108. Adapter pin 124 may also pass through holes in shear plate(s) 204 located between adapter wall 112 and hitch mount 102 to hold multi-hitch 106 in place.

Latch mechanism 132 can be mounted on adapter wall 112 above adapter channel 114. Accordingly, latch bolt 134 of latch mechanism 132 may be spaced above longitudinal axis 110 and/or mounting tube 108 when hitch mount 102 is received within adapter channel 114. By positioning latch mechanism 132 above longitudinal axis 110, a pintle loop may be held above mounting tube 108, i.e., higher than an axis extending through a receiver tube on a tow vehicle. As such, the pintle loop can be spaced apart from the ground by sufficient distance to avoid scraping the towing kit 100 when driving over bumps or through potholes.

Latch mechanism 132 can include a bolt receiver 506 mounted on adapter wall 112. For example, bolt receiver 506 may be welded to the top of pintle adapter 104, or otherwise attached to adapter wall 112. Latch bolt 134 may be slidably disposed within bolt receiver 506. That is, latch bolt 134 may be moved relative to bolt receiver 506 between an extended state (FIG. 5) and a retracted state (FIG. 12.) In an embodiment, latch bolt 134 has a cylindrical body extending longitudinally. The cylindrical body can be moved axially between the extended state and the retracted state. Axial movement of latch bolt 134 may be modulated, however, by an arm 508 extending laterally from latch bolt 134. Arm 508 may extend from latch bolt 134 through a wall of bolt receiver 506 to allow a user to grip and move arm 508. Movement of arm 508 can effect rotational or axial movement of latch bolt 134. More particularly, arm 508 may extend through a locking channel 510 in the wall of bolt receiver 506. Locking channel 510 may have a longitudinal portion between a distal locking notch and a proximal locking notch. Arm 508 is shown resting in the distal locking notch of locking channel 510 in FIG. 5 and in the proximal locking notch in FIG. 12. When arm 508 is positioned in the distal locking notch, axial movement of arm 508 is restricted, and latch bolt 134 is locked in the extended state. When a user rotates arm 508 upward from the distal locking notch and pulls arm 508 proximally within the longitudinal portion, latch bolt 134 is retracted to the retracted state. Arm 508 can be rotated downward into the proximal locking notch to lock latch bolt 134 in the retracted state. The bolt action movement can be reversed to advance latch bolt 134 into the extended state.

Referring to FIG. 6, a rear perspective view of a pintle adapter is shown in accordance with an embodiment. Adapter channel 114 defined by adapter wall 112 may have a profile that is larger than an outer profile of mounting tube 108. To maintain a close fit between pintle adapter 104 and hitch mount 102, pintle adapter 104 may include an adapter receiver hole 602 in a rear wall 604. Rear wall 604 may extend across a backside of pintle adapter 104, e.g., orthogonal to adapter wall 112 holding latch mechanism 132. Adapter receiver hole 602 may be sized to receive and conform to an outer profile of mounting tube 108. For example, adapter receiver hole 602 may be a square hole having 2 inch long sides. Accordingly, mounting tube 108 may extend through adapter channel 114 into adapter receiver hole 602 to be received by rear wall 604 in a sliding fit.

Pintle adapter 104 can have adapter channel 114 larger than mounting tube 108 to create an annular gap between an inner surface of adapter wall 112 and an outer surface of mounting tube 108. The annular gap can be a rectangular annular gap with a gap distance large enough to receive a portion of multi-hitch 106. One or more shear plates 204 of multi-hitch 106 may extend into the annular gap between adapter wall 112 and mounting tube 108 in certain towing configurations. For example, when towing kit 100 is in the pintle hitch towing mode, shear plate(s) 204 of multi-hitch 106 may be disposed between adapter wall 112 of pintle adapter 104 and mounting tube 108 of hitch mount 102.

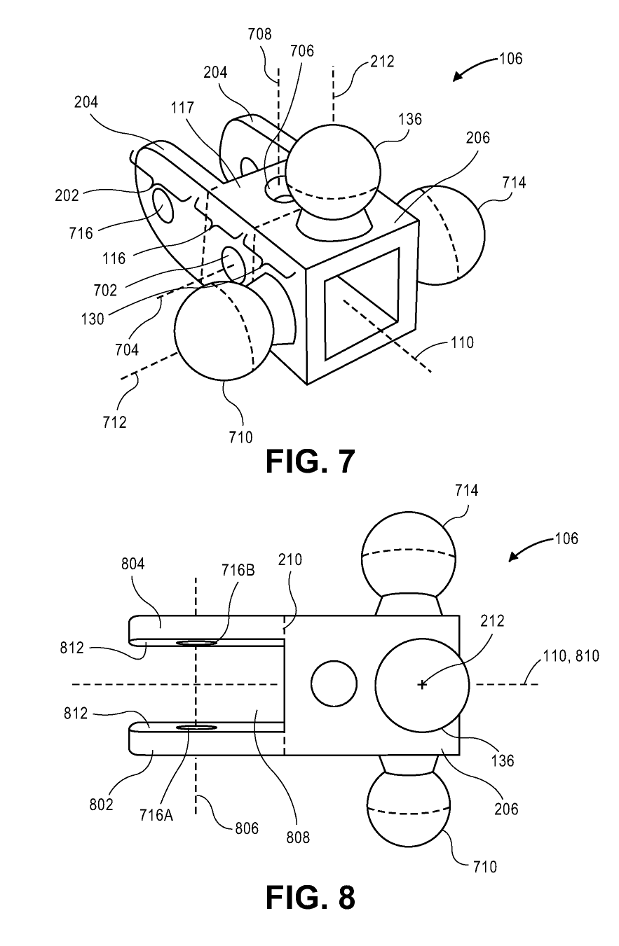

Referring to FIG. 7, a perspective view of a multi-hitch is shown in accordance with an embodiment. Collar section 116 of multi-hitch 106 can be fastened to mounting tube 108 in several rotational configurations. Collar section 116 can include a collar tube 117 that extends around and conforms to mounting tube 108 of hitch mount 102. Collar section 116 can include a first pair of collar holes 702 in collar tube 117. First pair of collar holes 702 can include a first collar hole and a second collar hole in walls of collar tube 117 on opposite sides of longitudinal axis 110. First pair of collar holes 702 may be aligned along a first collar hole axis 704 extending perpendicular to longitudinal axis 110. First collar hole axis 704 may be aligned with a mounting hole axis 404 and mounting tube 108. The collar hole axis and mounting hole axis 404 may be horizontal such that, when a tow pin 122 is inserted through the aligned holes, hitch ball 136 may extend along hitch ball axis 212 in a vertical direction. Accordingly, when collar section 116 is mounted on mounting tube 108 in a first rotational configuration, hitch ball 136 may be used to pull a load having a ball hitch of a first size.

Collar section 116 can include two pairs of collar holes, e.g., first pair of collar holes 702 and a second pair of collar holes 706 in collar tube 117. The two pairs of collar holes may be aligned along respective collar hole axes. For example, whereas first pair of collar holes 702 is aligned along first collar hole axis 704, second pair of collar holes 706 may be aligned along a second collar hole axis 708 extending perpendicular to longitudinal axis 110. Second collar hole axis 708 may also be perpendicular to first collar hole axis 704, i.e., first collar hole axis 704 and second collar hole axis 708 may be perpendicular to each other. Accordingly, when first collar hole axis 704 extends in the horizontal direction, second collar hole axis 708 extends in the vertical direction. By rotating collar section 116 about mounting tube 108, e.g., by removing multi-hitch 106 from hitch mount 102, rotating multi-hitch 106 by 90 degrees, and placing multi-hitch 106 back onto mounting tube 108, the orientation of second collar hole axis 708 may be changed into the horizontal direction.

Ball mount section 130 includes mounting wall 206, which may extend partly or completely around longitudinal axis 110. For example, mounting wall 206 may be a tubular wall to receive mounting tube 108 of hitch mount 102. That is, when ball mount section 130 of multi-hitch 106 is mounted on mounting tube 108, mounting wall 206 may extend completely around mounting tube 108.

Mounting wall 206 can receive a second hitch ball 710. Second hitch ball 710 may extend from mounting wall 206 along a second hitch ball axis 712. Second hitch ball axis 712 may be parallel to first collar hole axis 704, and thus, second hitch ball axis 712 may extend perpendicular to both longitudinal axis 110 and hitch ball axis 212. Accordingly, when second collar hole axis 708 is oriented in the horizontal direction, second hitch ball 710 can extend upward (or downward) from ball mount section 130 in the vertical direction. Accordingly, when collar section 116 is mounted on mounting tube 108 in a second rotational configuration, second hitch ball 710 may be used to pull a load having a ball hitch of a second size.

Mounting wall 206 of ball mount section 130 may receive a third hitch ball 714 and/or a fourth hitch ball (not shown) on different surfaces of mounting wall 206. For example, the third hitch ball 714 can extend along an axis that is coaxial with second hitch ball axis 712. Accordingly, by rotating collar section 116 about mounting tube 108 in a third rotational configuration, third hitch ball 714 may be oriented upward to pull a load having a ball hitch of a third size.

In an embodiment, clevis mount section 202 includes a pair of shear holes in the shear plates 204 that cantilever from second end 210 of collar section 116. Shear holes may be aligned along a shear hole axis (FIG. 8). The shear hole axis may extend parallel to first collar hole axis 704. For example, the shear hole axis and first collar hole axis 704 may be parallel within a horizontal plane, such that the horizontal plane passes through shear holes 716 and first pair of collar holes 702.

Referring to FIG. 8, a top view of a multi-hitch is shown in accordance with an embodiment. Clevis mount section 202 may include a first shear plate 802 extending from second end 210 of collar tube 117 on a first side of longitudinal axis 110, and a second shear plate 804 extending from second end 210 on a second side of longitudinal axis 110. The first shear hole 716A may extend through first shear plate 802 and a second shear hole 716B may extend through second shear plate 804. The pair of shear holes can be aligned along a shear hole axis 806 that extends perpendicular to longitudinal plane 810. In an embodiment, first shear plate 802 and second shear plate 804 are parallel plates separated by a gap 808. Longitudinal axis 110 may pass through gap 808. Similarly, a longitudinal plane 810 that contains longitudinal axis 110 may extend through gap 808. The shear plates 204 may include respective inner surfaces 812 facing each other across gap 808. Shear hole axis 806 may extend perpendicular to inner surfaces 812 of shear plates 204, and thus, inner surfaces 812 may be parallel to longitudinal plane 810. For example, longitudinal plane 810 may bisect gap 808, and thus, longitudinal plane 810 may pass through hitch ball 136 extending along an axis 212 perpendicular to longitudinal axis 110.

As described above, each hitch ball 136 mounted on mounting wall 206 can have a different ball size. For example, first hitch ball 136, second hitch ball 710, and third hitch ball 714 may each have ball sizes corresponding to a different type of trailer ball hitch. In an embodiment, hitch ball 136 extending along hitch ball axis 212 that is contained within longitudinal plane 810 has a largest ball size. For example, the first hitch ball 136 may have a ball diameter of 2⅝ inches. By comparison, second hitch ball 710 and third hitch ball 714 may have diameters of 1⅞ inches and 2 inches, respectively.

Mounting the largest hitch ball 136 along longitudinal plane 810 may be advantageous in the pintle hitch towing mode. The pintle hitch towing mode may be used to carry heavier loads, and thus, mounting the largest hitch ball 136 on the top surface of mounting wall 206 can configure towing kit 100 to be arranged in a strongest configuration in the pintle hitch towing mode.

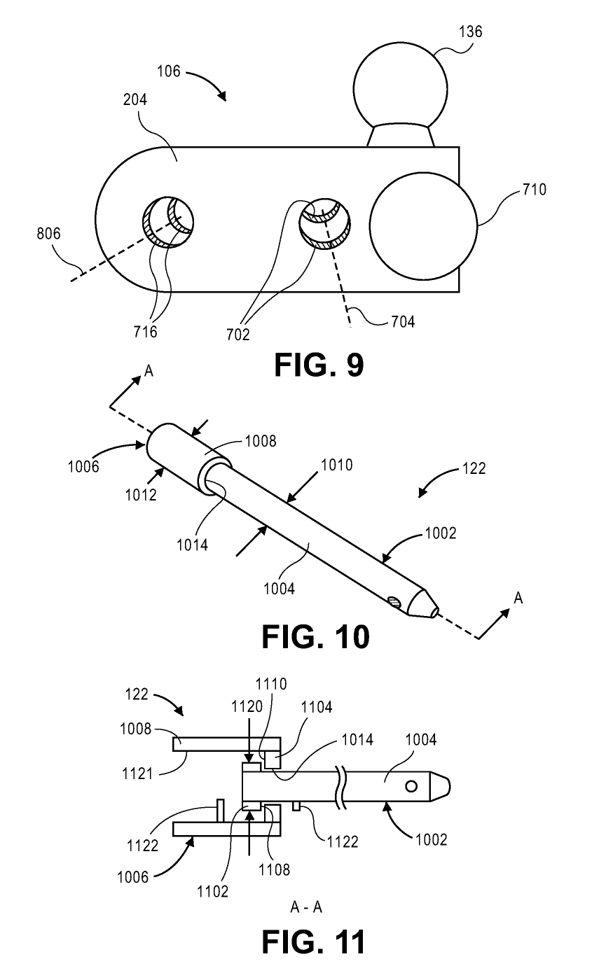

Referring to FIG. 9, a side view of a multi-hitch is shown in accordance with an embodiment. A longitudinal spacing between shear hole axis 806 and collar hole axis 704 can be equal to a longitudinal spacing between two sets of mounting hole pairs 402 in mounting tube 108. Accordingly, when multi-hitch 106 is inserted over mounting tube 108, tow pins 122 may be placed through mounting tube 108 and both collar section 116 and clevis mount section 202 of multi-hitch 106. For example, in the pintle hitch towing mode, shear plates 204 of clevis mount section 202 may insert into the annular gap between adapter wall 112 and mounting tube 108. Furthermore, the shear holes 716 extending through clevis mount section 202 may be aligned with both of adapter holes 502 in adapter wall 112 and mounting holes 402 in mounting tube 108. Adapter pin 124 may be inserted through adapter holes 502, shear holes 716, and mounting holes 402. Similarly, in the pintle hitch towing mode, hitch pin 126 may be inserted through first pair of collar holes 702 and mounting holes 402 in mounting tube 108. Accordingly, axial loading on multi-hitch 106 by a load being towed can be distributed to the surfaces of collar section 116 and clevis mount section 202. More particularly, the shear force applied by the load can be shared by both adapter pin 124 and hitch pin 126. Multi-hitch 106 can be coupled to mounting tube 108 at both clevis mount section 202 and collar section 116 in a ball hitch towing mode as well. For example, when latch bolt 134 is retracted and a load is being towed by hitch ball, which may be the largest hitch ball 136, the load can be distributed to the surfaces of collar section 116 and clevis mount section 202. Such load distribution can increase an overall strength of towing kit 100 in the pintle hitch towing mode and the ball hitch towing mode, which are generally the modes used to pull the heaviest types of loads.

Referring to FIG. 10, a perspective view of a tow pin is shown in accordance with an embodiment. The illustrated tow pin 122 can be adapter pin 124, hitch pin 126, or any other tow pin included in towing kit 100. In an embodiment, tow pin 122 includes two portions that are rotationally coupled to one another. Tow pin 122 can include a pin portion 1002 having a shaft 1004 that is inserted into any of the hole pairs described above. For example, tow pin 122 may be adapter pin 124, and shaft 1004 may be inserted through adapter wall 112, shear plates 204, and mounting tube 108 to fasten pintle adapter 104 and multi-hitch 106 to hitch mount 102.

Tow pin 122 may also include a head portion 1006 having a head sidewall 1008. In an embodiment, head portion 1006 includes a tubular section having head sidewall 1008, and thus, an outer surface of head sidewall 1008 may be cylindrical. Head sidewall 1008 may be coaxial with an outer surface of shaft 1004. Head sidewall 1008 can have a larger dimension than shaft 1004. For example, shaft 1004 may have a shaft dimension 1010, e.g., a diameter, sized smaller than a corresponding hole pair. By contrast, head sidewall 1008 may have a head dimension 1012, e.g., a head diameter, sized larger than the corresponding hole pair. Thus, when shaft 1004 is inserted through the hole pair, head portion 1006 may not fit through the hole pair and may retain pin portion 1002.

Shaft 1004 may be retained within head portion 1006. For example, a head hole 1014 may extend through head portion 1006, and shaft 1004 may extend through head hole 1014. Shaft 1004 may be rotatable within head hole 1014 such that pin portion 1002 rotates relative to head portion 1006 about a common axis.

Referring to FIG. 11, a sectional view, taken about line A-A of FIG. 10, of a tow pin is shown in accordance with an embodiment. Pin portion 1002 and head portion 1006 of tow pin 122 can have respective bushings that make contact with one another and can slide over each other when pin portion 1002 rotates relative to head portion 1006. For example, shaft 1004 may extend from a shaft base 1102, which may be a first bushing of the sliding joint. Shaft base 1102 may be an annular section welded or press fit onto an end of shaft 1004. Accordingly, shaft 1004 may extend from shaft base 1102 through head hole 1014 of head portion 1006. Similarly, head sidewall 1008 may extend from a head base 1104, which may be a second bushing of the sliding joint. Head base 1104 may be an annular section welded or press fit into an end of head sidewall 1008. Head base 1104 can be mounted on shaft 1004 such that shaft 1004 extends through head hole 1014. Shaft base 1102 can have a shaft base dimension 1120, and shaft base dimension 1120 may be larger than shaft dimension 1010 of shaft 1004. Accordingly, shaft base 1102 can be contained within an inner volume of head sidewall 1008, and may contact head base 1104. That is, shaft base 1102 may be retained within head portion 1006, and may have a distal face 1108 in sliding contact with a proximal face 1110 of head base 1104.

When shaft 1004 rotates within head hole 1014, pin portion 1002 can rotate relative to head portion 1006. As described above, tether 302 may be attached to tow pin 122, and more particularly, a tether 302 may have an end attached to head sidewall 1008. Accordingly, when pin portion 1002 rotates during operation, head portion 1006 may rotate freely to allow tether 302 to sag downward and not become wrapped around tow pin 122 or towing kit 100.

In an embodiment, axial movement between pin portion 1002 and head portion 1006 may be restricted. More particularly, tow pin 122 may include one or more retainers 1122 to constrain shaft base 1102 near head base 1104. Head sidewall 1008 may extend from head base 1104 around shaft base 1102. Accordingly, an inner surface 1121 of head sidewall 1008 can extend around shaft base 1102. In an embodiment, a retainer 1122 extends inward from head sidewall 1008. Shaft base 1102 may be disposed between retainer 1122 and head base 1104. Thus, axial movement of shaft 1004 relative to head portion 1006 can be restricted to a distance that exists between retainer 1122 and proximal face 1110. Similarly, a retainer 1122 may extend from an outer surface of shaft 1004 on an opposite side of head base 1104 than shaft base 1102. That is, retainer 1122 may extend outward from shaft 1004, and head base 1104 may be disposed between retainer 1122 and shaft base 1102. Thus, axial movement of shaft 1004 relative to head portion 1006 can be restricted to a distance that exists between retainer 1122 and distal face 1108.

Referring to FIG. 12, a side view of a towing kit in a ball hitch towing mode is shown in accordance with an embodiment. The pictured configuration can be referred to as a ball hitch towing mode because a ball coupler of a ball hitch (not shown) attached to the load can be retained on hitch ball 136 extending upward from mounting wall 206. The ball coupler can rest on hitch ball 136 such that a portion of the coupler is in a space between hitch ball 136 and latch bolt 134. More particularly, latch bolt 134 may be retracted to allow the ball coupler to fit into the space. The ball coupler can conform to an outer surface of hitch ball 136. Accordingly, the load having the ball coupler can be pulled by the tow vehicle connected to towing kit 100.

Referring to FIG. 13, a side view of a towing kit in a clevis hitch towing mode is shown in accordance with an embodiment. The pictured configuration can be referred to as a clevis hitch towing mode because clevis mount section 202 extends forward to receive a tongue (not shown) attached to the load. The tongue can fit between inner surfaces 812. A clevis pin 1302 can be dropped through shear holes in the shear plates 204 to engage a corresponding hole in the tongue. Similarly, hitch pin 126 may be inserted through second pair of collar holes 706 and a corresponding mounting hole pair 402 to fix multi-hitch 106 to hitch mount 102. Accordingly, the load having the tongue can be pulled by the tow vehicle connected to towing kit 100.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A towing kit, comprising:
a hitch mount having a mounting tube extending along a longitudinal axis;
a pintle adapter including an adapter wall around an adapter channel to receive the mounting tube, and a latch mechanism mounted on the adapter wall; and
a multi-hitch including
a collar section having a collar tube around a collar channel to receive the mounting tube,
a ball mount section having a mounting wall extending from a first end of the collar tube, wherein the mounting wall is to receive a hitch ball along a hitch ball axis extending perpendicular to the longitudinal axis, and
a clevis mount section having a pair of shear plates extending from a second end of the collar tube.

2. The towing kit of claim 1, wherein the collar section includes a pair of collar holes in the collar tube aligned along a collar hole axis extending perpendicular to the longitudinal axis, and wherein the clevis mount section includes a pair of shear holes in the shear plates aligned along a shear hole axis extending parallel to the collar hole axis.

3. The towing kit of claim 2, wherein the hitch mount includes four mounting hole pairs in the mounting tube, wherein each pair of mounting holes is aligned along a respective mounting hole axis, and wherein the mounting hole axes are parallel to each other.

4. The towing kit of claim 3, wherein the pintle adapter includes a pair of adapter holes in the adapter wall, wherein the pair of adapter holes is aligned along an adapter hole axis.

5. The towing kit of claim 4, wherein the latch mechanism includes a bolt receiver mounted on the adapter wall, and a latch bolt slidably disposed within the bolt receiver and movable relative to the bolt receiver between an extended state and a retracted state.

6. The towing kit of claim 2 further comprising an adapter pin and a tether, wherein the tether includes a first tether end attached to the adapter pin and a second tether end attached to the pintle adapter.

7. The towing kit of claim 2, wherein the collar section includes a second pair of collar holes in the collar tube, wherein the second pair of collar holes is aligned along a second collar hole axis extending perpendicular to both the longitudinal axis and the collar hole axis.

8. The towing kit of claim 7, wherein the mounting wall extends around the mounting tube, wherein the mounting wall is to receive a second hitch ball along a second hitch ball axis extending perpendicular to both the longitudinal axis and the hitch ball axis.

9. The towing kit of claim 8 further comprising the hitch ball and the second hitch ball mounted on the mounting wall, wherein the hitch balls have different ball sizes.

10. The towing kit of claim 2, wherein the shear plates include respective inner surfaces facing each other, and wherein the shear hole axis extends perpendicular to the inner surfaces.

11. A towing multi-hitch, comprising:
a collar section having a collar tube,
a ball mount section having a mounting wall extending from a first end of the collar tube,
a plurality of hitch balls mounted on the mounting wall, and
a clevis mount section having a first shear plate and a second shear plate extending from a second end of the collar tube, wherein a first shear hole extends through the first shear plate and a second shear hole extends through the second shear plate, and wherein the first shear hole and the second shear hole are aligned along a shear hole axis.

12. The towing multi-hitch of claim 11, wherein the collar section includes two pairs of collar holes, wherein the pairs of collar holes are aligned along respective collar hole axes, and wherein the collar hole axes are perpendicular to each other.

13. The towing multi-hitch of claim 12, wherein the mounting wall is tubular, and wherein the first shear plate and the second shear plate are parallel plates separated by a gap.

14. The towing multi-hitch of claim 13, wherein the plurality of hitch balls have different ball sizes.

15. The towing multi-hitch of claim 14, wherein a longitudinal plane is parallel to the shear plates and bisects the gap, and wherein the longitudinal plane passes through a hitch ball having a largest ball size.

16. A tow pin, comprising:
a pin portion including a shaft extending from a shaft base, wherein the shaft base has a shaft base dimension larger than a shaft dimension of the shaft; and
a head portion including a head sidewall and a head base, wherein the head base has a head hole and is mounted on the shaft such that the shaft extends through the head hole, and wherein the head sidewall extends from the head base around the shaft base.

17. The tow pin of claim 16, wherein the shaft base has a distal face in sliding contact with a proximal face of the head base.

18. The tow pin of claim 17, wherein the shaft is rotatable within the head hole in the head base.

19. The tow pin of claim 18 further comprising a retainer extending from the head sidewall, wherein the shaft base is between the retainer and the head base.

20. The tow pin of claim 18 further comprising a retainer extending from the shaft, wherein the head base is between the retainer and the shaft base.
